(19) United States
(12) Patent Application Publication
(10) Pub. No.: US 2007/0178277 A1
(43) Pub. Date: Aug. 2, 2007

(54) Plastics-compound board-shaped material and manufacturing method thereof

(76) Inventor: Shih-Ying Lu, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/319,626

(22) Filed: Dec. 29, 2005

(51) Int. Cl. B32B 3/10

(52) U.S. Cl. 428/137

(57) ABSTRACT

A polyethylene terephthalate (PET) board-shaped material, and a polypropylene (PP) board-shaped material are chosen and used as materials of a plastics-compound board-shaped material; second, glue is applied to form glue layers on opposed sides of both the polyethylene terephthalate board-shaped material and the polypropylene board-shaped material; third, both the PET and the PP board-shaped materials are heated to 130° C. so that they are in a half-melted plasticized state; finally, both the PET and the PP board-shaped materials are stuck together with the help of a machine in order to form a plastics-compound board-shaped material, which is to be used as the materials of plastic tiles, hand tool boxes, outer plastic board parts of jazz drums and the materials in building and printing as well.

### BACKGROUND OF THE INVENTION

1. Field of the invention

The present invention relates to a method for manufacturing plastics-compound board-shaped material, which comprises a PET board-shaped material, and a PP board-shaped material stuck to the PET board-shaped material after applying glue and heating, and has high surface hardness, heat-resistant and cold-resistant capabilities, suitable for use as the materials of plastic tiles, hand tool boxes, outer plastic board parts of jazz drums and the materials in printing and building as well.

2. Brief Description of the Prior Art

Plastics are among major materials of various appliances that we use in our life. The industry is developing even better and more price-competitive plastic materials in order to benefit the consumers, and advancement of plastics compounding techniques will help realize this goal. Bright future of plastic industry can be anticipated owing to the plastics compounding technology.

All plastics can be divided into two groups: thermosetting and thermoplastic plastics. Thermosetting plastics become hard, and won't melt or dissolve in solvent after having been heated and shaped, e.g. the shells of common household electronic appliances. Thermoplastic plastics will become soft and bendable when heated but hard when cold, e.g. coverings of electrical wires, and plastic pipes. Polyving chloride (PVC) is among the most widely used plastic materials. Because polyving chloride has transparentness, water resistant feature, insulating ability, good extensibility, and low manufacturing cost in mass production therefore PVC products are very popular and inexpensive. However, PVC has several disadvantages: it has less thermostability and cold resistant ability, poor machinability, and low strength, and ages easily; PVC is a polymer of polyvinyl chloride, which will release bad-smelling gas when burnt; further, cancer-causing dioxin will be produced when chlorine is burnt. Therefore, use of PVC can spoil the environment.

### SUMMARY OF THE INVENTION

It is a main object of the invention to provide a plastics-compound material to replace PVC, and the method for manufacturing same, thus reducing the use of environment harmful chlorine. In the present invention, first a polyethylene terephthalate (PET) board-shaped material, and a polypropylene (PP) board-shaped material are chosen and used as the materials of a plastics-compound board-shaped material. Second, glue is applied to form glue layers on opposed sides of both the PET and the PP board-shaped materials. Third, both the PET and the PP board-shaped materials are heated to 130° C. so that they are in a half-melted plasticized state. Finally, both the PET and the PP board-shaped materials are stuck together with the help of a machine to form a plastics-compound board-shaped material. Therefore, the plastics-compound board-shaped material has high surface hardness, heat-resistant and cold-resistant capabilities, and can be used as the materials of plastic tiles, hand tool boxes, outer plastic board parts of jazz drums as well as the materials in printing and building.

### BRIEF DESCRIPTION OF THE DRAWINGS

The present invention will be better understood by referring to the accompanying drawings, wherein:

FIG. 1 is a flow chart of the manufacturing method in the present invention, and

FIG. 2 is a sectional view of the plastics-compound board-shaped material of the present invention.

### DETAILED DESCRIPTION OF THE PREFERRED EMBODIMENTS

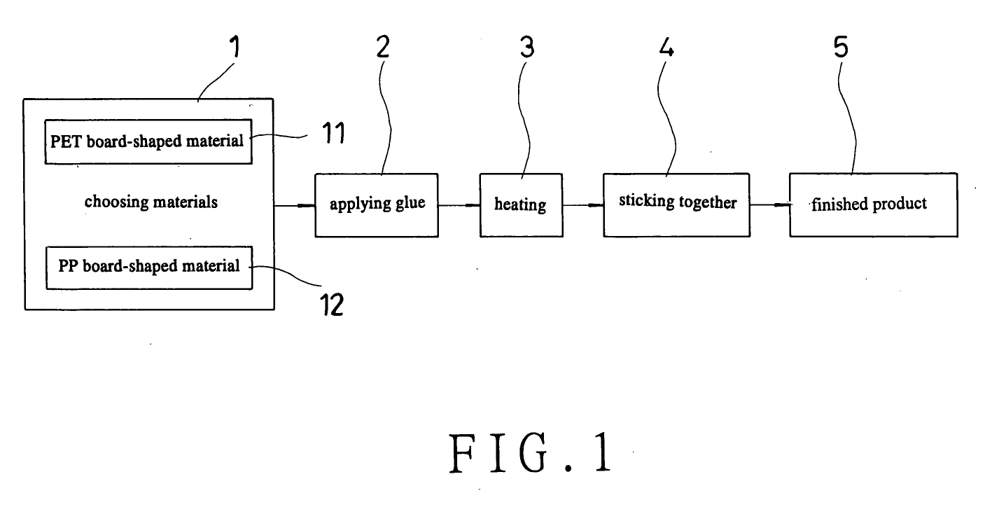

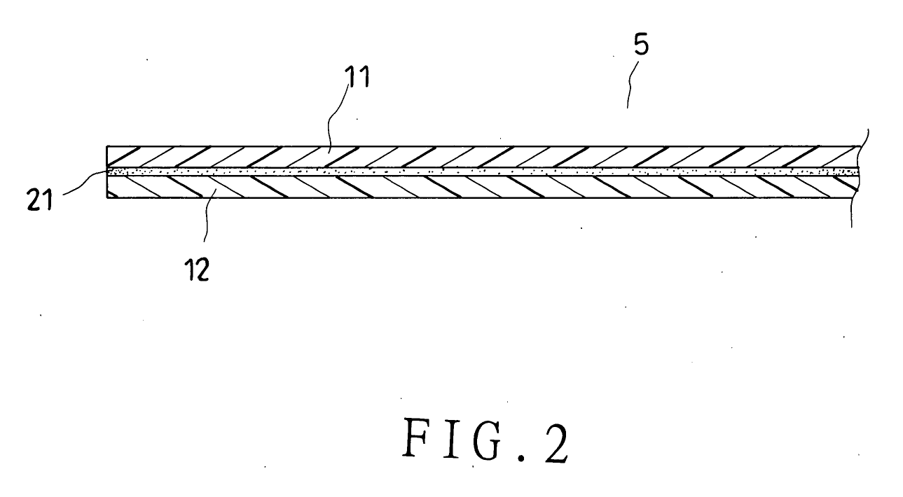

Referring to FIGS. 1 and 2, a preferred embodiment of a method for manufacturing a plastics-compound board-shaped material includes the following steps:

1. choosing materials (1): choose a polyethylene terephthalate (PET) board-shaped material 11, and a polypropylene (PP) board-shaped material 12 in the light of the fact that both polyethylene terephthalate (PET) and polypropylene (PP) are nontoxic, and PET has good tenacity, and is hit-resistant, wear-resistant, heat-resistant, and cold-resistant, and PP has high temperature-resistant capability (resistant to a temperature higher than 100° C.), and it is strong alkaline resistant and strong acid resistant;

2. applying glue (2): apply glue to form glue layers 21 on opposed sides of the polyethylene terephthalate (PET) board-shaped material 11 and the polypropylene (PP) board-shaped material 12;

3. heating (3): heat the polyethylene terephthalate (PET) board-shaped material 11 and the polypropylene (PP) board-shaped material 12 to 130° C. so that they are in half-melted plasticized state; and

4. sticking together (4): stick together both the polyethylene terephthalate board-shaped material 11 and the polypropylene board-shaped material 12 to form a plastics-compound board-shaped material 5 with the help of a machine.

A preferred embodiment of a plastics-compound board-shaped material in the present invention includes a polyethylene terephthalate (PET) board-shaped material, and a polypropylene (PP) board-shaped material stuck on the polyethylene terephthalate board-shaped material, as shown in FIG. 2.

The plastics-compound board-shaped material of the invention has the following advantages:

1. It has high surface hardness, and is wear and scratch resistant.

2. It is highly heat-resistant, capable of resisting about 80° C. temperature, having a better heat-resistant capability than PVC, which can resist only 68° C. temperature.

3. It can resist a low temperature approximating to −10° C.

4. It can be used as the materials of various plastic products and in many technical realms. For example, it can be used as the materials of plastic tiles, hand tool boxes, outer plastic board parts of jazz drums, and the materials in building, plating, and printing.

5. The plastics-compound board-shaped material is made of nontoxic PET and PP, and won't release toxic substance when it is burnt. Therefore, it is very environment-friendly.

What is claimed is:

1. A plastics-compound board-shaped material, comprising
a polyethylene terephthalate (PET) board-shaped material; and
a polypropylene (PP) board-shaped material; the polypropylene board-shaped material and the polyethylene terephthalate board-shaped material being stuck together after applying glue thereon and heating.

2. A method for manufacturing a plastics-compound board-shaped. material, comprising following steps:
(1) choosing materials: choose a polyethylene terephthalate board-shaped material, and a polypropylene board-shaped material;
(2) applying glue: apply glue to form glue layers on opposed sides of the polyethylene terephthalate board-shaped material and the polypropyleneboard-shaped material;
(3) heating: heat the polyethylene terephthalate board-shaped material and the polypropylene board-shaped material to 130° C. so that they are in a half-melted plasticized state; and
(4) sticking together: stick together both the polyethylene terephthalate board-shaped material and the polypropylene board-shaped material to form a plastics-compound board-shaped material with help of a machine.
